(19) United States
(12) Patent Application Publication
(10) Pub. No.: US 2024/0054504 A1
(43) Pub. Date: Feb. 15, 2024

(54) REFERENCE CONTENT IMPORT FOR FOOTPRINT

(71) Applicant: SAP SE, Walldorf (DE)

(72) Inventors: Swarnava Chatterjee, Varanasi (IN); Neha Soni, Bihar (IN); Raghavendra Nataraj, Bangalore (IN); Ranjit Alapati, Vijayawada (IN); Selina Grade, Ruelzheim (DE); Stefan Feickert, Birkenau (DE)

(73) Assignee: SAP SE, Walldorf (DE)

(21) Appl. No.: 17/888,112

(22) Filed: Aug. 15, 2022

(51) Int. Cl. G06Q 30/00

(52) U.S. Cl. CPC G06Q 30/018

(57) ABSTRACT

Sustainability reference content from a variety of sources can be imported into a canonical format for a variety of uses. Product footprint analysis can be performed by accessing the imported sustainability reference content. The canonical format can support a variety of features relating to normalization of units, validity time window, geographical indications, and content quality. API access can be provided to facilitate content update. Automated data import from lifecycle assessment content providers can be supported along with manual input of data from arbitrary sources such as users, vendors, suppliers, or the like. Scope can go beyond footprint analysis to environmental health compliance and other use cases.

### FIELD

The field generally relates to lifecycle analysis of products, such as product footprint analysis based on emission or other factors.

### BACKGROUND

As consumers become more familiar with the processes behind the production of the products they consume, they demand more information about the sustainability of such products. For example, a box of cookies may contain ingredients that come from various places around the world. The total environmental product footprint may involve activities related to the constituent ingredients (e.g., cocoa, sugar, etc.) as well as related activities (e.g., processing the cocoa, transporting the cocoa, storing the cocoa, etc.).

The simple question of “How does this product impact the environment?” can thus become a complicated matter. Although there are some sources for environmental impact data, there remains a large disconnect between such data and a final calculation of environmental impact. Accordingly, improvements in the field are still needed.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a computer-implemented method comprises a computer-implemented method comprising receiving a persisted representation of reference content comprising one or more reference emission factors; converting the persisted representation of the reference content to a canonical format, wherein the reference content in the canonical format comprises the one or more reference emission factors; and communicating the reference content in the canonical format to a footprint analysis engine.

In another embodiment, a computing system comprises at least one hardware processor; at least one memory coupled to the at least one hardware processor; and one or more non-transitory computer-readable media having stored therein computer-executable instructions that, when executed by the computing system, cause the computing system to perform: receiving a persisted representation of reference content comprising one or more reference emission factors; organizing the persisted representation of reference content according to a pre-defined template; converting the organized, persisted representation of reference content to a canonical format, wherein the reference content in the canonical format comprises the one or more reference emission factors; and communicating the reference content in the canonical format to a footprint analysis engine.

In another embodiment, one or more non-transitory computer-readable media comprising computer-executable instructions that, when executed by a computing system, cause the computing system to perform operations comprising: receiving a persisted representation of reference content comprising one or more reference emission factors; organizing the persisted representation of reference content according to a pre-defined template; converting the organized, persisted representation of the reference content to a canonical format, wherein the reference content in the canonical format comprises the one or more reference emission factors; communicating the reference content in the canonical format to a footprint analysis engine; and by the footprint analysis engine, with the reference content in the canonical format, calculating a footprint for an item, wherein the calculating incorporates at least one of the one or more reference emission factors.

As described herein, a variety of other features and advantages can be incorporated into the technologies as desired.

### BRIEF DESCRIPTION OF THE DRAWINGS

FIG. 1 is a block diagram of an example system implementing sustainability reference content import for product footprint analysis and other applications.

FIG. 2 is a flowchart of an example method of implementing sustainability reference content import for product footprint analysis.

FIG. 3 is a block diagram of example sources of sustainability reference content for product footprint analysis.

FIG. 4 is a block diagram showing an example system calculating a product footprint metric using data converted to canonical format.

FIG. 5 is a block diagram of an example architecture implementing sustainability reference content import for product footprint analysis.

FIG. 6 is a block diagram of an example sustainability reference content staging area.

FIG. 7 is a block diagram of an example sustainability reference content canonical format.

FIG. 8 is a block diagram of an example sustainability reference content data model for a canonical format.

FIGS. 9, 10, 11, and 12 are screenshots of a user interface for sustainability reference content import for product footprint analysis.

FIG. 13 is a block diagram of an example geographical location indication annotation.

FIG. 14 is a block diagram of an example validity time window implementation for emission factors.

FIG. 15 is a block diagram of an example computing system in which described embodiments can be implemented.

FIG. 16 is a block diagram of an example cloud computing environment that can be used in conjunction with the technologies described herein.

### DETAILED DESCRIPTION

### Example 1—Overview

Sustainability reference content is available from a variety of sources, including lifecycle assessment content providers. Such content typically includes one or more datasets that specify emissions factors. Basing sustainability calculations on such content can be helpful because information behind the calculations can provide some assurance that the data are current, accurate, or the like.

Such providers may specialize in their domain, geographics, content availability, content quality, content coverage, industry and functional scope, and other such factors.

However, an emerging problem is a lack of standards across such content providers. There is no general guidance on the format of the data due to the lack of a central authority to control such data publication, so each provider ends up defining their own proprietary format. In practice, a product footprint calculation can involve multiple product components that have data in different content providers. Due to the lack of a unifying standard, it becomes difficult or impossible to understand the different data models and perform environmental impact analysis efficiently or consistently.

Further, sustainability reference content can come from other sources such as custom data, vendor data, and the like as described herein.

To address the problem, data can be converted into a canonical format for sustainability reference content. After conversion, product footprint calculations can proceed even under conditions where data is sourced from a variety of providers. Further, the format can preserve the data source, allowing for auditability of the calculated result.

As described herein, further features related to an API for accessing data in the canonical format can be provided to allow for dynamic update of the sustainability reference content, which can be helpful as conditions change over time, leading to more current data, more accurate data, or both.

As described herein, sustainability reference content can come from a variety of sources beyond the lifecycle assessment content provider, including custom, user-provided data, vendor-provided data, or the like.

Having established the canonical format for the sustainability reference content, the content can be used not only for product footprint calculation, but more advanced footprint management (e.g., exploring possible ways to balance or minimize the footprint), clean operations (e.g., product compliance) applications, and environmental health and safety management (e.g., compliance) applications.

Other techniques such as validity time windows can be used as described herein.

The described technologies thus offer considerable improvements over conventional life cycle assessment techniques.

### Example 2—Example System Implementing Sustainability Reference Content Import for Product Footprint Analysis

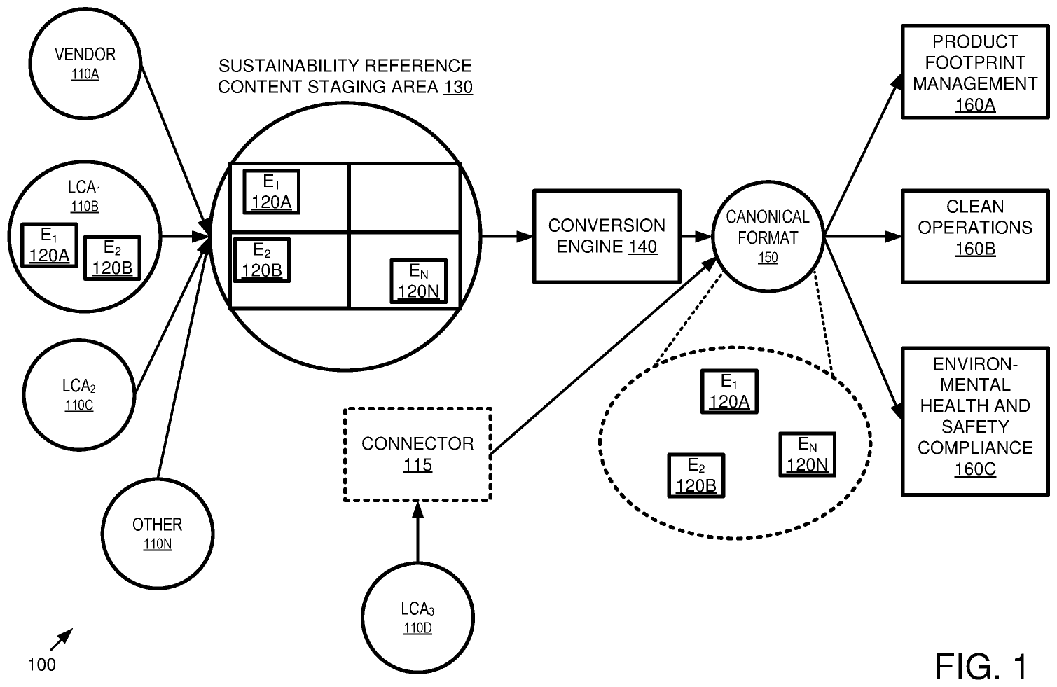

FIG. 1 is a block diagram of an example system 100 implementing sustainability reference content import for product footprint analysis and other applications as shown. In the example, the system 100 can accept sustainability reference content 110A-N from a variety of sources, such as a vendor, a life cycle assessment content provider, or other source. As described herein, such content comprises one or more emission factors 120A, 120B. The system 100 can organize the sustainability reference content in a sustainability reference content staging area 130, which comprises the emission factors 120A-N.

A conversion engine 140 can accept the organized information 130 and output the sustainability reference content in a canonical format 150. As shown, the canonical format 150 comprises the emission factors 120A-N, although they may be converted to different units as described herein. The conversion engine 140 can iterate over the values of incoming data and perform various conversions, including converting units. The engine 140 can also take further actions such as propagating data to different geographical-based entries or converting geographical indications to a format understandable by downstream processing.

As shown, some content 110D may be imported via a connector 115, thus bypassing the area 130 and engine 140. However, in practice, the connector 115 can employ elements of the area 130 and functionality of the engine 140.

After conversion, the information in the canonical format 150 can be used for a variety of applications. Although product footprint management 160A is primarily described herein, the canonical format 150 can also be used in other applications such as clean operations (e.g., product compliance) applications 160B, environmental health and safety (EHS) management (e.g., compliance a/k/a “conformity”) applications 160C, and the like. Environmental impact in different countries, regions, and industries can be supported with the single canonical format.

The system 100 can also comprise one or more non-transitory computer-readable media having stored therein computer-executable instructions that, when executed by the computing system, cause the computing system to perform any of the methods described herein.

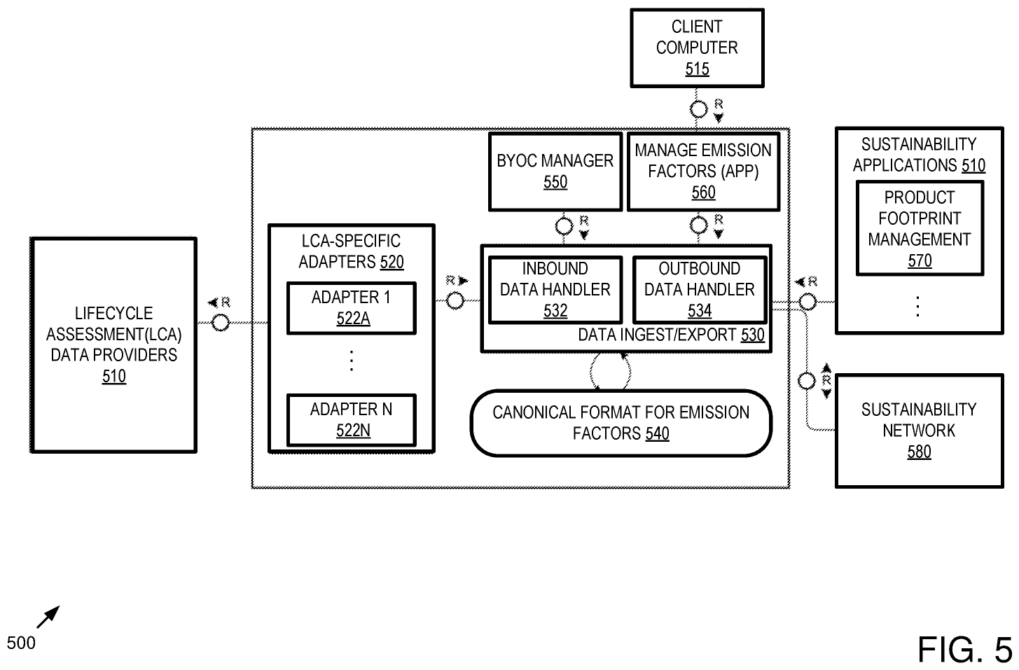

In practice, the systems shown herein, such as system 100, can vary in complexity, with additional functionality, more complex components, and the like. For example, the variety of sustainability reference content 110A-N can be quite large. Elements shown from the architecture of FIG. 5 can be included. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the sustainability reference content 110A-N, staging area 130, the canonical format 150, and the like can be stored (e.g., persisted) in one or more computer-readable storage media or computer-readable storage devices. The technologies described herein can be generic to the specifics of operating systems or hardware and can be applied in any variety of environments to take advantage of the described features.

### Example 3—Example Method Implementing Sustainability Reference Content Import for Product Footprint Analysis

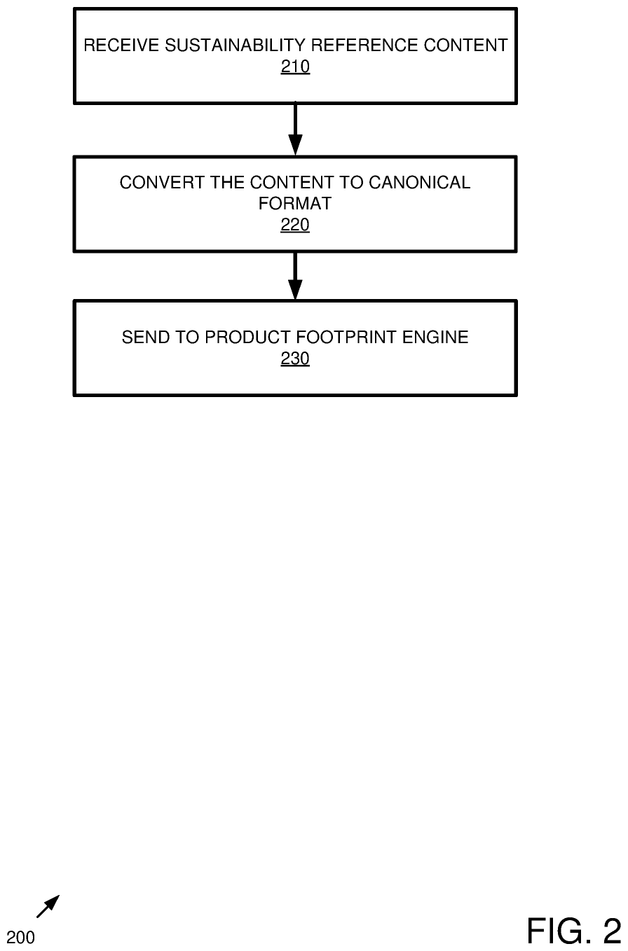

FIG. 2 is a flowchart of an example method 200 of sustainability reference content import for product footprint analysis and can be performed, for example, by the system of FIG. 1. The automated nature of the method 200 can be used in a variety of situations such as importing sustainability reference content from a life cycle assessment content provider or other sources as described herein.

In the example, at 210, a persisted representation of sustainability reference content is received. As described herein, such content comprises one or more reference emission factors. In practice, the data may be of a lifecycle-assessment-content-provider-specific format. Such a condition presents a problem for product footprint analysis because such calculations typically require information organized according to certain units, information about geographical specificity, validity information, quality information, or the like. In practice, the incoming content may lack such information or specify it in a proprietary or idiosyncratic manner.

At 220, the content is converted into a canonical format. The canonical format can comprise the one or more reference emission factors, although they may be annotated or converted to different units. As described herein, the conversion can comprise organizing the persisted representation of the sustainability reference content according to a pre-defined template. The organized, persisted representation of the sustainability reference content can then be converted into the canonical format. Conversion can include annotating with geographical notations, considering time validity windows, and the like.

At 230, the sustainability reference content in the canonical format is communicated to a product footprint analysis engine or other application for incorporation in sustainability calculations.

As described herein, converting can comprise organizing the persisted representation of reference content according to a pre-defined template. The organized, persisted representation of the reference content can then be converted to the canonical format. Such a template can serve as a staging area into which data is first persisted. Missing values can be populated manually if needed as described herein. Such a pre-defined template can comprise sections for emission data set, emission factors, dataset classifications, dataset attributes, and dataset qualities. The dataset attributes section can support arbitrary attributes.

Converting the persisted representation of the reference content to the canonical format can comprise persisting metadata specifying a source of the reference content. For example, if the source of the reference content in a life cycle assessment content provider, metadata specifying a unique identifier specified for a product component by the LCA provider can be persisted. Subsequently, during auditing, the source can be specified to allow verification of the calculation.

As described herein, a footprint for a product can be calculated (e.g., by the product footprint analysis engine, which can be a component of a product footprint management application). Such calculating can incorporate the one or more reference emission factors. The basic calculation is to aggregate (sum) products of emission factor and quantity for the constituent ingredients/materials/activities of the product.

The reference content can comprise a plurality of reference emission factors for respective geographical locations. Such reference emission factors can be converted into the canonical format. Subsequently, when calculating a footprint for a product, the calculating can choose one of the reference emission factors for respective geographical locations and applies the chosen reference emission factor during footprint calculation. Choosing can be based on a geographical location indicated in a database (e.g., ERP database) for a product.

Converting into canonical format can comprise converting a reference emission factor into units specified by the canonical format. Subsequently, when calculating a footprint for the product, the converted reference emission factor can be multiplied by a quantity during footprint calculation. For example, the format can specify kilograms for weight, kilometers for distance, and the like.

Different transportation modes can also be supported.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving content can be described as sending a content depending on perspective.

### Example 4—Example Sustainability Reference Content

In any of the examples herein, sustainability reference content (or simply “reference content”) can specify environmental impact related to product components such as a raw material, constituent ingredients, activities, or the like. For example, reference emission factors are specified that indicate an amount of greenhouse gas emission per unit of product component, which can be a measure of weight, volume, distance, area, or the like.

### Example 5—Example Product Components

In any of the examples herein, a product component can be a part of a product, whether physical or action (e.g., a material, ingredient, activity, or the like). To determine the footprint of a product, a footprint for separate components of the product can be calculated and combined as described herein. For example, for a cookie manufacturer, separate components can comprise sugar, flour, cocoa, and the like. For a cocoa manufacturer, components may include the activities related to producing the cocoa (e.g., drying, processing, packaging, and the like).

A product is sometimes called an “item” herein.

### Example 6—Example Canonical Format

In any of the examples herein, the information about a reference emission factor can be persisted in a canonical format. Such a format can be a generalized, generic, common, and/or normalized format of the data that can be interpreted uniformly across applications such as product footprint management applications, clean operations (e.g., product compliance) applications, and environmental health and safety management (e.g., compliance) applications. The format can also be generalized across different countries and regions. Further, the format can be generalized across different industries.

As described herein, such data can be persisted on a per-product component basis and indicate a reference emission factor. Additional information such as metadata indicating a source of the data, geographical indicators, and validity windows can be included. Values can be converted to uniform units of measure. Although the format is pre-defined, arbitrary values can be supported via specification of an attribute name and attribute value.

Consequently, when footprint analysis is performed, the analysis can account for a wide variety of scenarios and situations, such as different geographical locations, validity windows, and the like. Further, auditing can be supported because the canonical format includes information about the source and quality of the data.

### Example 7—Example Connector

In any of the examples herein, a connector can be used to support automated import of sustainability reference content. A lifecycle-assessment-content-provider-centric connector can be used that accounts for the format of a particular lifecycle assessment content provider.

In practice, although import is automated, some data can be entered manually or inferred. For example, the source, geographical indication, and the like may not actually be present in the sustainability reference content. For example, a dataset may specify a reference emission factor but not contain information on source or geographical indication. Accordingly, responsive to determining that information (e.g., geographical location) is missing from the sustainability reference content, a user interface can be displayed by which such information can be noted as missing. Manual entry via the user interface can be accepted to complete the data persisted in the canonical format. For example, emission factors can be annotated with (e.g., stored as related to) such data.

### Example 8—Example API

In any of the examples herein, an API can be used to support automatic import of data in canonical format. For example, a library of sustainability reference content can be periodically updated via an API that supports import of data to the library. Such data can already be of canonical format, or the API can force specification of attributes that are converted into canonical format.

Via an API, an indication can be received that additional sustainability reference content is available. Such an indication can be communicated via an alert or message indicating the source, general content, description, or the like. Automated retrieval, automatic push of data, or approval of storage can be implemented.

Responsive to the indication, the additional sustainability reference content can be persisted in the library.

Security and auditing of the API can be supported.

### Example 9—Example Arbitrary Sourced Data

In any of the examples herein, data from arbitrary sources can be supported. For example, if an authorized user identifier wishes to add sustainability reference content that was provided by a vendor or supplier, such can be supported by manual entry, copy-and-paste, or the like. A user interface can accept such data and then persist in canonical format.

### Example 10—Example Product Footprint Management

In any of the examples herein, a product footprint can be calculated (e.g., a metric value calculated based on reference emission factors or the like). In practice, such a product footprint can be calculated as part of footprint analysis. For convenience of the calculation, footprint analysis functionality, including footprint calculation, can be integrated into a footprint management application that provides a wide variety of functionality, including importing reference data, mapping reference data to ERP databases, calculating product footprint, providing auditing functionality, and the like.

Although the term “product footprint” is used herein, such term is intended to cover both products proper as well as services (e.g., the service is the product).

### Example 11—Example Geographical Indications

In any of the examples herein, geographical indications can be used to indicate where a reference emission factor is valid. For example, the factor may vary based on the country, region, or the like. An emission factor can vary greatly depending on the location. For example, cocoa production in one country may result in a different emission factor than cocoa production in another country due to a variety of reasons.

The canonical format can support indications that span multiple countries (e.g., a wildcard, a region, or the like). Alternatively, when converting the data into canonical format, multiple entries can be populated for a single incoming entry. For example, if a region indicates multiple countries, the canonical format can contain plural entries (e.g., entries for different countries in the region). Other indicators such as “RoW” (rest of the world) can be supported so that a single country or region can be specified along with “rest of the world” to indicate that the factor is for any location except the specified country or region.

Subsequently, when footprint analysis is performed, a reference emission factor that matches the geographical location for which the footprint is calculated can be chosen and applied. The geographical location can be drawn from the ERP database or specified manually as part of the footprint analysis process.

### Example 12—Example Sources of Sustainability Reference Content

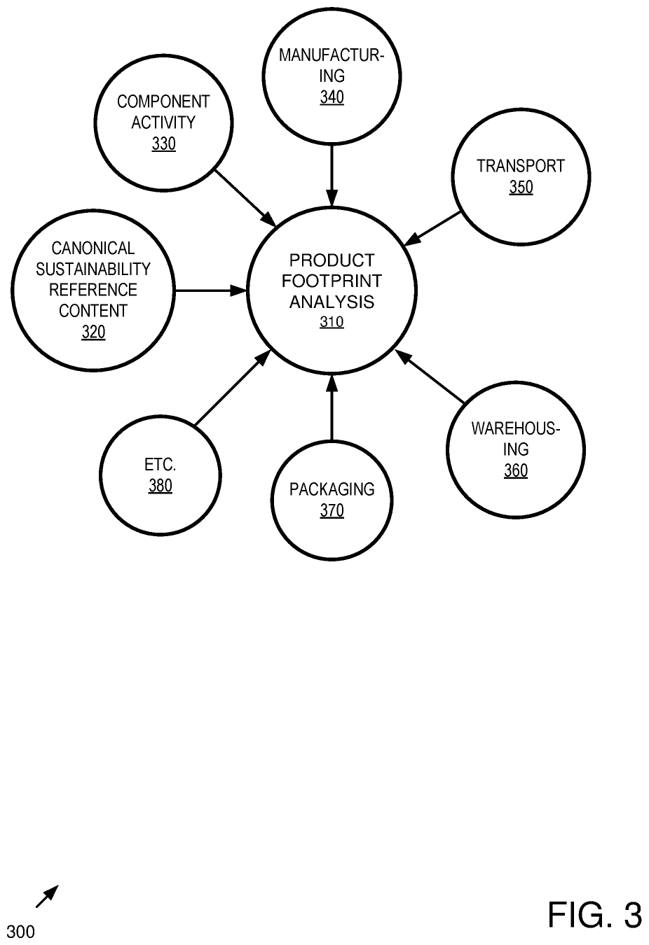

FIG. 3 is a block diagram of example sources 300 of sustainability reference content for product footprint analysis 310. As shown, a variety of factors can be incorporated into the analysis 310. Component activity 330 can include a wide variety of activity related to components of the product (e.g., ingredients, materials, or the like). Manufacturing impact 340, transport impact 350, warehousing 360, packaging 370, and other impacts 380 can be included.

As shown sustainability reference content 320 in a canonical format can be used to calculate any of the impacts shown. For example, for transport 350, the mode of transport as well as the reference emission factor in combination with the distance traveled can be used to calculate product footprint. The canonical format can specify how the mode of transport and reference emission factor are persisted and specified. The distance traveled can come from or be derived from an ERP database (e.g., the distance between source and destination). Multiplication by the proper emission factor results in the product footprint calculation for the transport impact. In practice, the other impacts can be aggregated, resulting in a combined footprint.

Footprint calculation can be done for different footprint categories like the publicly known Carbon Footprint for Greenhouse Gases (GHG), water consumption or land fill needs. The Greenhouse Gas Protocol specifies a framework for footprint calculations. Scope can include direct and indirect impacts, including upstream activities, reporting company activities, and downstream activities.

For example, purchase of electricity, steam, heating, and cooling for use are example indirect upstream activities that can be included within a scope of level 2.

Purchased goods and services, capital goods, fuel and energy related activities, transformation and distribution activities, waste generated in operations, business travel, employee commuting, and leased assets can be upstream indirect activities within a scope of level 3.

Direct activities within a scope of level 1 can include company facilities, company vehicles, and the like.

Indirect downstream activities within a scope of level 3 can include transformation and distribution, processing of products, use of sold products, end-of-life treatment of sold products, leased assets, franchises, investments, and the like.

The Greenhouse Gas Protocol, specifically the Product Lifecycle Standard, provides a general model for CO₂ footprint calculation.

Impacts can include CO₂, CH₄, N₂O, HFCs, PFCs, SF₆, NF₃, and the like.

In general, a typical enterprise purchases materials from various suppliers (e.g., scope 3), uses electricity and/or fuel energy sources for manufacturing operations (e.g., scope 2), converts raw materials to finished or semi-finished products (e.g., scope 1), and sells finished products to customers (e.g., scope 3) or provides a service to customers (e.g., scope 1, 2).

In the value addition process, the enterprise emits greenhouse gases, utilizes natural capital like potable water, land, and the like. Any raw material, be it agricultural/farm products or semi-finished product brings its share of greenhouse gases such as Carbon Dioxide (CO₂) and methane. The footprint of greenhouse gases depends upon the processes employed. Some organizations use eco-friendly equipment and emission-friendly processing technologies.

For example, in a utility company, electrical energy may come from clean sources like solar power station, windmills, or a hydro power plant, or from unclean sources like a thermal power plant. Depending upon the source, the carbon footprint per watthour of energy produced varies.

Depending upon the production processes and technology/machinery in use, the enterprise may have higher or lower emissions of greenhouse gases. In addition, activities like employee commute, business travel, office climate control, warehouse cooling requirements, and the like bring their share of energy usage or emissions of greenhouse gases.

### Example 13—Example Integration into ERP Software

The canonical format can be used for an industry agnostic and efficient footprint calculation based on real-time business data located in ERPs such as SAP S/4HANA or others.

In any of the examples herein, the technologies can be integrated into enterprise resource planning (“ERP”) software. For example, a footprint management application can operate in an SAP S/4HANA environment or other ERP software that stores relevant data for an enterprise, providing access to product-related data relevant for calculating a product footprint.

The technologies described herein can be integrated into the Business Technology Platform of SAP to deliver a canonical format and an API with which a customer can import emission factors from any lifecycle assessment content provider to the canonical format.

### Example 14—Example System Calculating a Product Footprint Metric

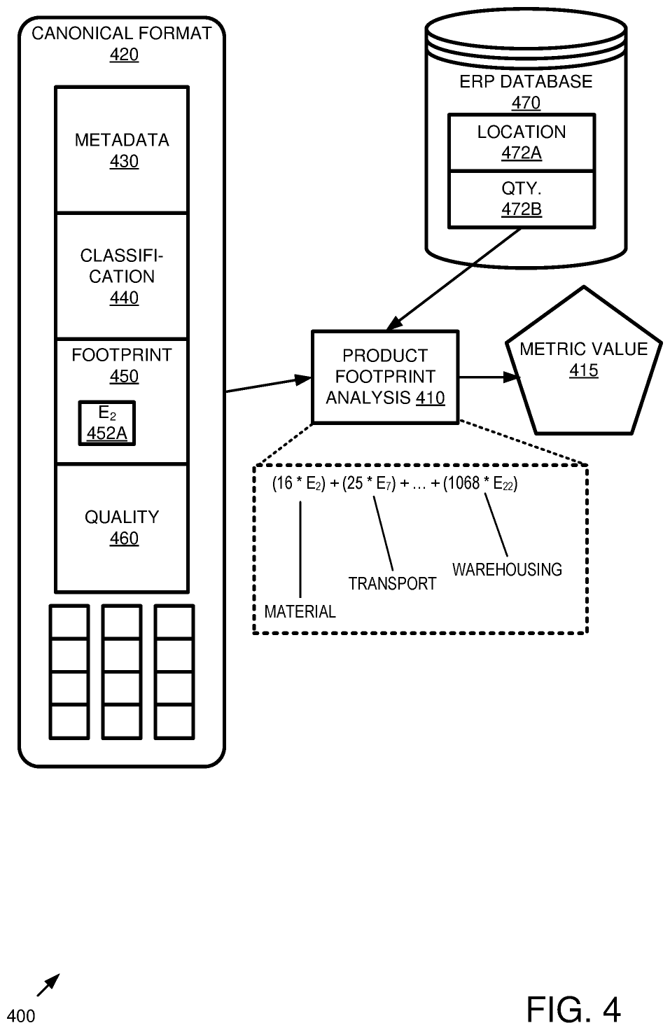

FIG. 4 is a block diagram showing an example system 400 calculating a product footprint metric 415 using data 420 converted to canonical format and can be used in any of the examples herein. In the example, product footprint analysis 410 accepts the data 420 in canonical format, including metadata 430, classification data 440, footprint data 450 that comprises a reference emission factor 452A, and quality data 460.

The metadata 430 can include information about source of the data, validity dates, versioning information, and the like.

Classification data 440 can comprise classification data that identifies product components (e.g., materials, ingredients, activities, or the like).

In practice, the data 420 can include reference emission factors for a plurality of different product components, activities, and the like.

The footprint data 450 can comprise one or more reference emission factors. In practice, geographical indications can be included that enable downstream processing to choose a reference emission factor correlated with a particular geographical location (e.g., manufacturing or transportation in region A may have a different impact that manufacturing or transportation in region B).

A wide variety of other information can be included such as the footprint calculation method used, the environment category, and the like, as described herein.

The quality 460 can include a quality indicator identifier and quality indicator value that provide quality attributes for the data that can be used in downstream processing as filters, notifications, optimization criteria, or the like.

As shown, the analysis 410 can also receive information from an ERP database 470. For example, information about geographical location 472A, quantity 472B, and the like can be used to choose among reference emission factors or be incorporated into the calculation itself (e.g., as a factor in multiplication, threshold analysis, or the like).

As shown, the calculation can combine (sum) impacts (e.g., material, transport, warehousing, and the like) to calculate a metric value 415, which is typically specified in units (e.g., CO₂e or the like). In the example, quantity 472B and location 472A are incorporated into the calculation.

For example, a quantity can specify a distance (e.g., miles, kilometers), amount of a component (e.g., mass of material), square feet (e.g., for warehouse space), or the like. The criteria for choosing among reference emission factors can include geography (e.g., the product is stored in a specified location), component name (e.g., the reference factor is for a specified material, and quality (e.g., the computation is required to be of a specified accuracy, based on information that complies with a specified standard, or the like). Such criteria can be drawn from the ERP database 470 or specified as part of the calculation criteria (e.g., in a user interface of a product footprint management application that performs the analysis 410).

Having the sustainability reference content in canonical format 420 enables the calculation to proceed in an automated manner without human intervention (e.g., to choose factors, convert units, and the like). Further, such a canonical format can prove indispensable when downstream optimization analysis is done (e.g., finding the best options for minimizing product footprint).

### Example 15—Example Architecture

FIG. 5 is a block diagram of an example architecture 500 implementing sustainability reference content import for product footprint analysis and can be used in any of the examples herein. In the example, one or more life cycle assessment (LCA) data providers 510 interface with the system along with a client computer 515 (e.g., operated by a sustainability data expert or other user).

Sustainability reference content can be imported from the data providers 510. LCA-specific adapters 520 (e.g., 522A and 522N) can accept the content from the providers 510, transform it into an acceptable format (e.g., into a staging area or directly into the canonical format) and provide to the data ingest/export 530, which comprises an inbound data handler 532 and an outbound data handler 534.

The internal representation of the emission factors can be stored in the canonical format 540 as described herein, which serves as a generalized representation of the data that can be used across a variety of applications.

Users can bring their own content using the BYOC Manager 550, which can also transform or stage incoming content for transformation into the canonical format 540.

A client computer 515 can be used to manage the data via a manipulate emission factors application 560, which can provide functionality for adding, revising, updating, or subscribing to sustainability reference content.

The information 540 in canonical format can be used to support a wide variety of sustainability application as described herein, including product footprint management 570.

The sustainability network 580 can be used to receive alerts about content, update content, share content, or the like.

### Example 16—Example Staging Area

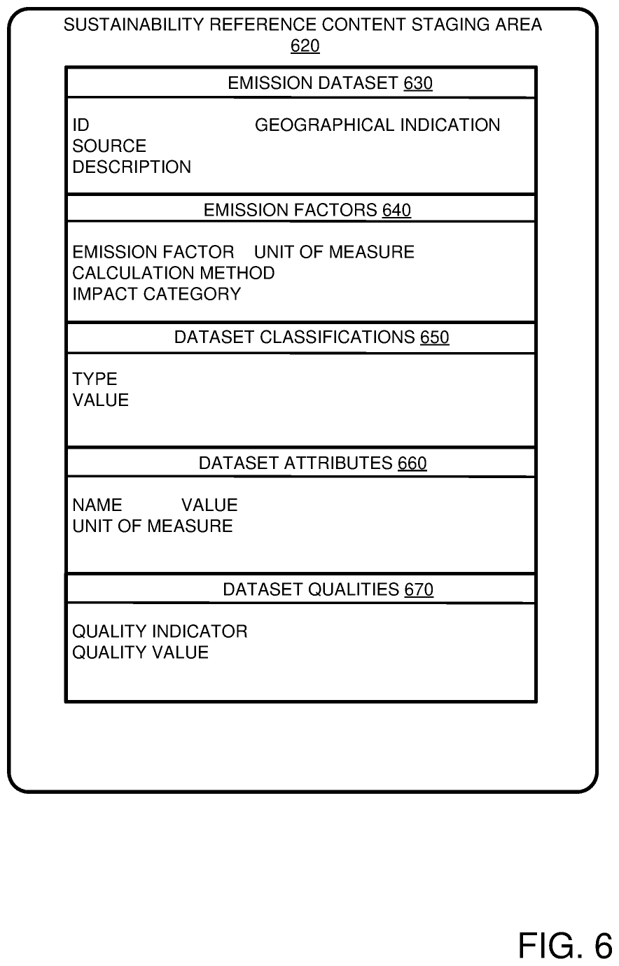

FIG. 6 is a block diagram of an example sustainability reference content staging area 620 and can be used in any of the examples herein. In the example, there are an emission dataset 630, emission factors 640, dataset classifications 650, dataset attributes 660, and dataset qualities 670. Such a staging area 620 can take the form of a pre-defined template into which data is organized. Geographical indications can take the form of country or region indicators as described herein.

The staging area can be used in an automated scenario where a user computer can approve or reject incoming data and provide a reason, comment, or the like. A user interface can display the incoming data for approval and receive an indication that the data is approved. Rejections can also be received with the reason, comment, or the like. Machine learning and rules can be developed by monitoring approval and rejection input to facilitate outlier detection, aiding in the approval process. Thus, overall accuracy of the determination can be improved by avoiding anomalous data.

A more detailed implementation of the staging area 620 can be implemented. For example, a spreadsheet can implement tabs for emission dataset, emission factors, dataset classifications, dataset attributes, and dataset qualities (quality attributes). Some fields can be indicated as mandatory. A source ID and dataset version can be used as a unique identifier within the spreadsheet. Multiple rows are supported in a single template file; thus, multiple datasets (e.g., for different products) can be persisted in the template.

The emission dataset sheet can include mandatory fields. It can contain a unique identifier for the dataset and other information such as country/region codes and the validity period for products or materials.

Example columns include sourceId (e.g., a value representing the identifier of the dataset), datasetVersion (e.g., a value that represents the iteration of the dataset), name (e.g., a name describing the product or activity that the dataset refers to), unitOfMeasure (e.g., the unit of measure of the product or activity that the dataset refers to, consistent with unit of measure maintained in physical goods movement data), quantity (e.g., quantity of product or activity to which emission factor refers in the defined unit of measure), country/region (e.g., a code or indicator that represents the country or region for which the dataset is valid. ISO codes can be supported), region (e.g., a value or indicator that represents regional information that complements the country/region assignment), validity window (e.g., from and to dates providing window in which the data set is valid), shortDescription (e.g., text that describes the product or activity in more detail), longDescription (e.g., text that describes the product or activity in more detail). Other fields can be included.

The emission factors sheet can specify the reference emission value for products or materials.

Example columns include key information that can specify the sourceID and datasetVersion. Other fields can include impact Category (e.g., the impact category of the associated emission factor such as GHG, greenhouse gases, or the like), footprintIndicator (e.g., a value that provides additional information on the emission factor determination, for example GWP 100a), emissionFactor (e.g., the reference emission factor value of a product or an activity. The aggregated value in CO2 equivalent can be specified.), footprintUnitOfMeasure (e.g., the unit of measure for the emission factor, such as kg), footprintCalcluationMethod (e.g., the standard based on which the emission factor was calculated, such as IPCC 2013 or the like).

The dataset classifications sheet can assign classification codes. Such codes can be based on the harmonized system (HS), Central Product Classification (CPC). Multiple codes can be assigned for a given dataset or product by creating multiple rows per dataset or product.

Example columns include key information that can specify the sourceID and datasetVersion. Other fields can include classificationType (e.g., the name of the classification system such as HS or CPC), classificationValue (e.g., the classification code), classificationVersion (e.g., the version of the classification system), and classificationHierarchy (e.g., a description of the classification code).

The dataset attributes sheet can add additional attributes to further describe the data set. For example, distinguishing features can be included to distinguish datasets.

Example columns include key information that can specify the sourceID and datasetVersion. Other fields can include attributeName (e.g., an attribute that further describes the product or activity), attributeValue (e.g., the value of the attribute), and unitOfMeasure (e.g., the unit of measurement of the property value).

The dataset qualities sheet can assign a quality indicator to the emission factor of the product associated with the dataset. For example, data can be evaluated for its precision or reliability. Any such quality indicator for a data set ID can be assigned (e.g., attribute name and attribute value).

Example columns include key information that can specify the sourceID and datasetVersion. Other fields can include qualityIndicator (e.g., the name of the quality indicator such as precision, reliability, or the like) and qualityValue (e.g., a value that represents approximate or precise).

Other sheets and fields can be included as appropriate.

### Example 17—Example Canonical Format

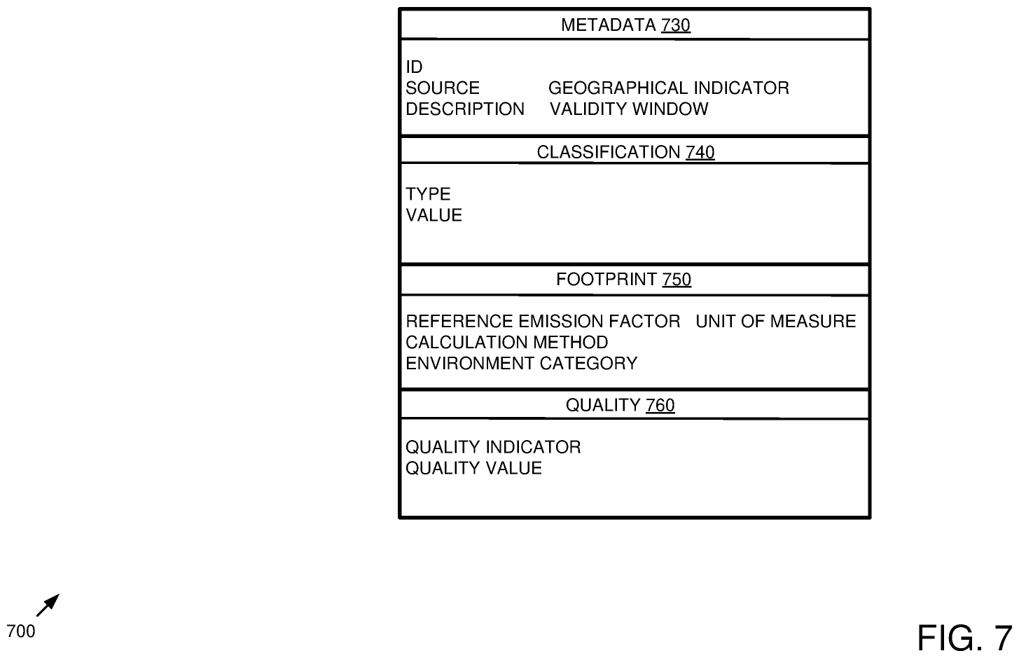

FIG. 7 is a block diagram of an example sustainability reference content canonical format 700 and can be used in any of the examples herein. In the example, the data is shown as groups for convenience. The data can be organized by dataset (e.g., a dataset for a particular product or activity).

The metadata 730 can include an identifier, an indication of the data's source, and a text description of the product or activity. Further information such as a geographical indicator and validity window can be included as described herein.

The classification 740 can include classification attributes helpful for mapping the product or activity of the dataset to a product or activity in the ERP system.

The footprint 750 can include the actual reference emission factor along with a unit of measure. The calculation method and environment category can also be included.

The quality 760 can include quality attributes (e.g., name and value of a quality attribute).

### Example 18—Example Canonical Format Data Model

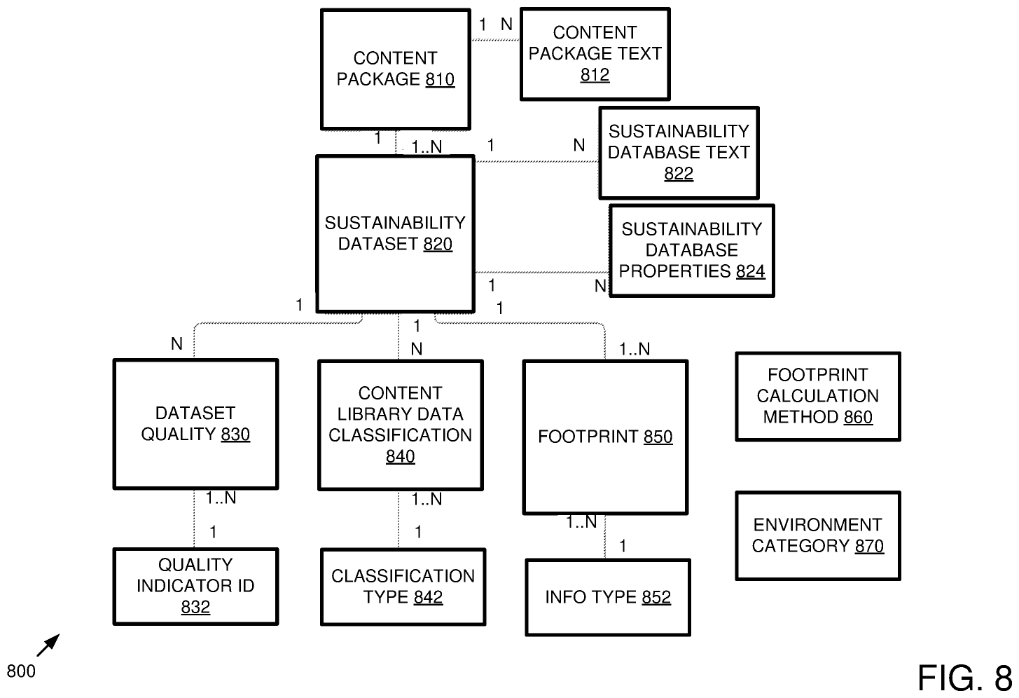

FIG. 8 is a block diagram of an example sustainability reference content data model 800 for a canonical format and can be used in any of the examples herein. For example, the fields from a staging area or template can be converted, mapped, or both to the fields shown. In practice, the objects can be persisted as database tables. In the example, the object ContentPackage 810 comprises a key field for PackageId and fields for PackageName, SourceOfPackage, Version, Status(Draft, Active, Deprecated), CreationDateTime, CreatedBy, LastModifiedDateTime, and Last ModifiedBy.

The object ContentPackageText 812 comprises key fields for PackageId and Language and a field for PackageDescription.

The object SustainabilityDataset 820 comprises a key field for InternalId, and fields for PakcageID, ExternalId, ExternalName, DatasetVersion, Country, ValidFromYear, ValidToYear, ReferenceQuantity, ReferenceUoM, CreationDateTime, CreatedBy, LastModifiedDateTime, and LastModifiedBy

The object SustainabilityDatabaseText 822 comprises key fields for InternalId and Language and fields for ShortDescriptionOfData and LongDescriptionOfData.

The object SustainabilityDatasetProperties 824 comprises a key field for PropertyId and fields for InternalId, PropertyName, PropertyValue, and UoMForProperty.

The object DatasetQuality 830 comprises a key field for DataSetQualityId and fields for InernalId, QualityIndicatorId, QualityIndicatorValue, CreationDateTime, CreatedBy, LastModifiedDateTime, and LastModifiedBy.

The object QualityIndicatorId 832 comprises a key field for QualityIndicatorId and a field for QualityIndicator.

The object ContentLibraryDataClassification 840 comprises a key field for DataSetClassificationId and fields for InternalId, ClassificationTypeId, ClassificaitonValue, CreationDateTime, CreatedBy, LastModifiedDateTime, and LastModifiedBy. The object ClassificationType 842 comprises a key field for ClassificationTypeId and fields for ClassificationType and ClassificationDescription.

The object Footprint 850 comprises a key field of FootprintDataId and fields for InternalId, InfoTypeId, CalcluationMethodId, EnvironmentCategoryId, ValueForFootprint, UoMForFootptint, CreationDaateTime, CreatedBy, LastModifiedDateTime, and LastModifiedBy.

The object InfoType 852 comprises a key field for InfoTypeId and fields for InfoType and InfoTypeDescription. Example info types comprise Carbon, Energy, GreenWater, GreyWater, and BlueWater.

The object FootPrintCalculationMethod 860 comprises a key field for CalculationMethodId and fields for CalculationMethod and CalculationMethodDescription. Example Calculation methods include EF-Midpoint, EF-Endpoint, CED-HHV, CED-LHV, and ManualStudy.

The object EnvironmentCategory 870 comprises a key field for EnvironmentCategryId and fields for EnvironmentCategory and EnvironmentCatagoryDescription. Example environment categories comprise Climate Change, Ozone Depletion, Water Resource Depletion, and None.

### Example 19—Example User Interface

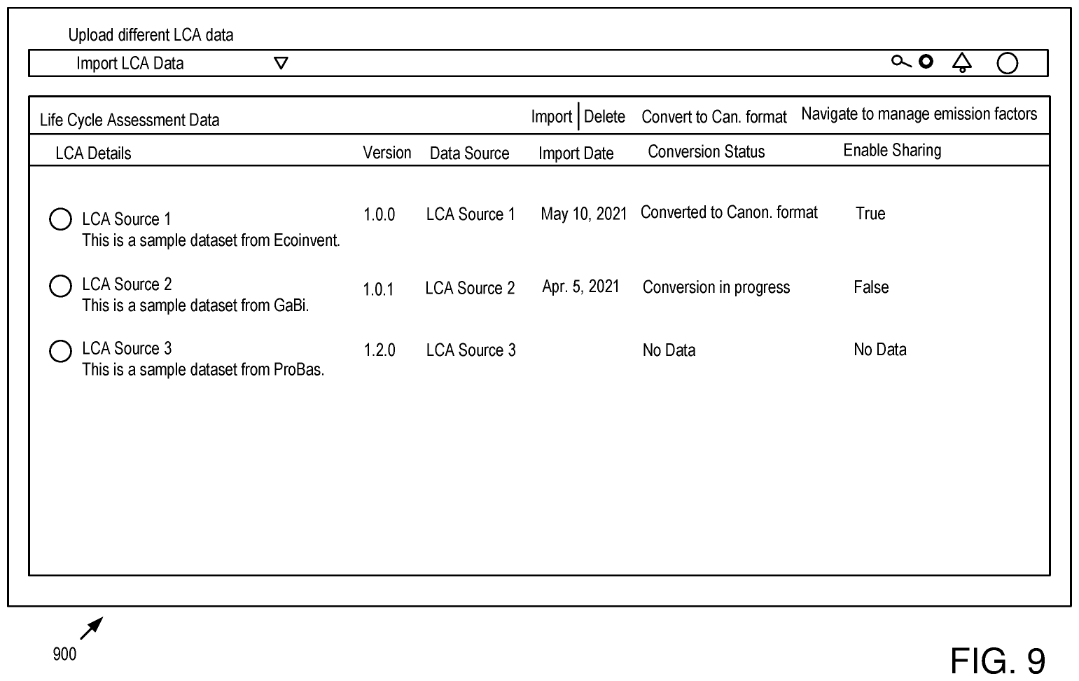

FIGS. 9, 10, 11, and 12 are screenshots of a user interface for sustainability reference content import for product footprint analysis and can be used in any of the examples herein. In the example, a product footprint management tool can present the user interface as part of an import functionality. FIG. 9 shows dataset choices. In practice, although the data is called a “dataset,” a single source can comprise plural datasets (e.g., for plural product components).

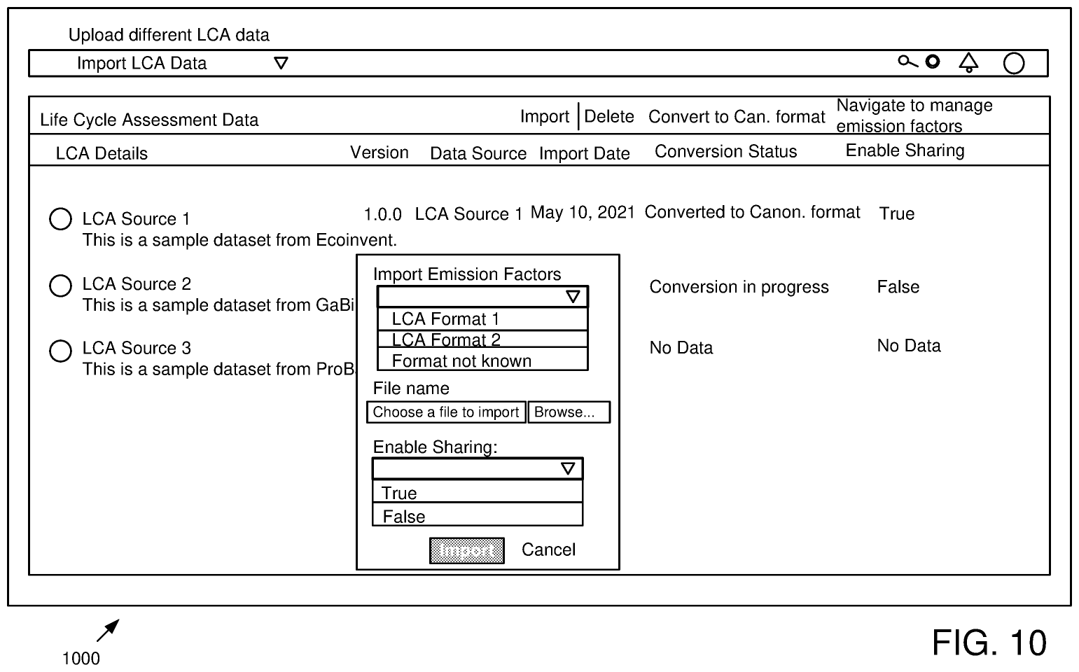

FIG. 10 shows a user interface for initiating the import functionality. The format can be specified, or auto-recognition of the format for a limited number of known formats can be employed.

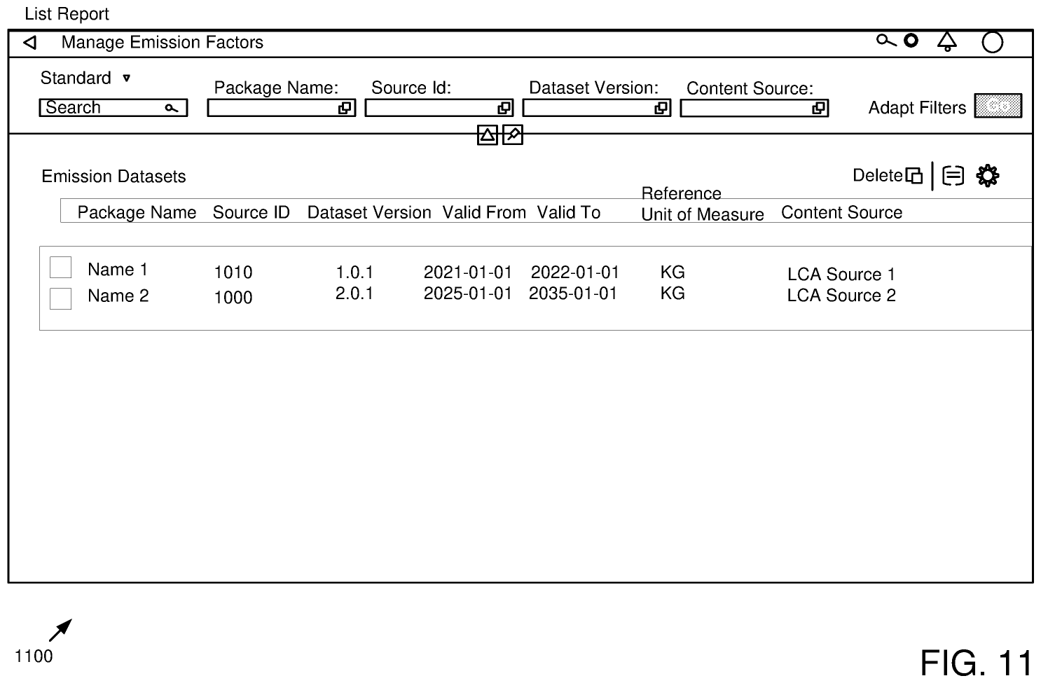

Upon import, the datasets in the file are listed in FIG. 11, and the user interface can select one or more of those shown.

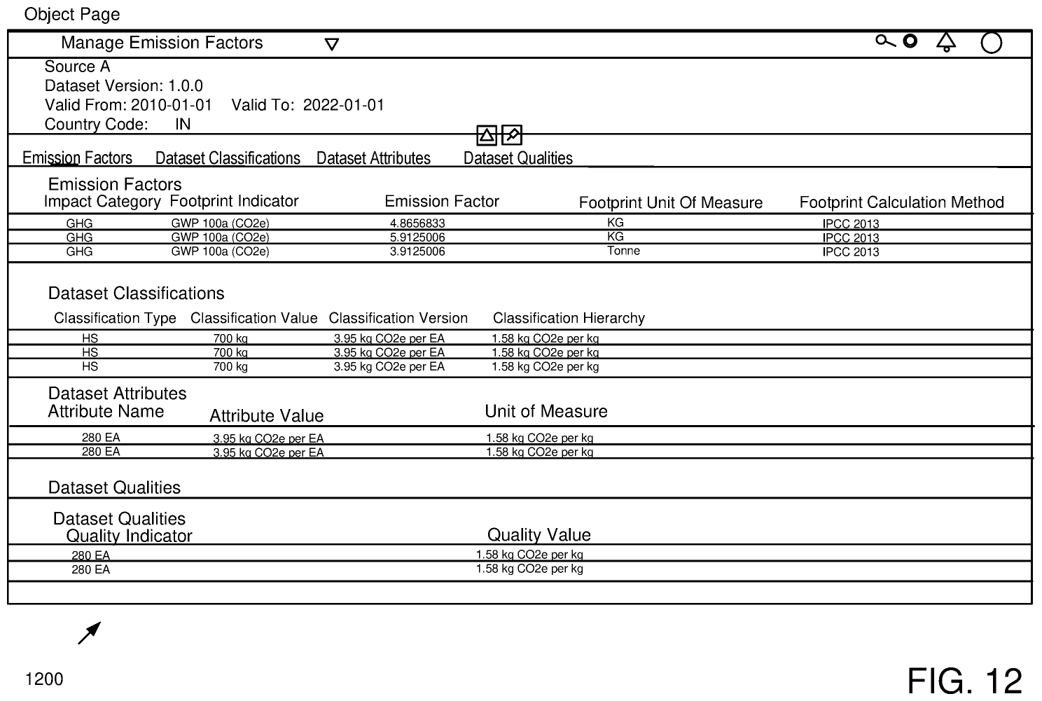

FIG. 12 shows the reference emission factors for the imported data.

### Example 20—Example Geographical Location Indication Annotation

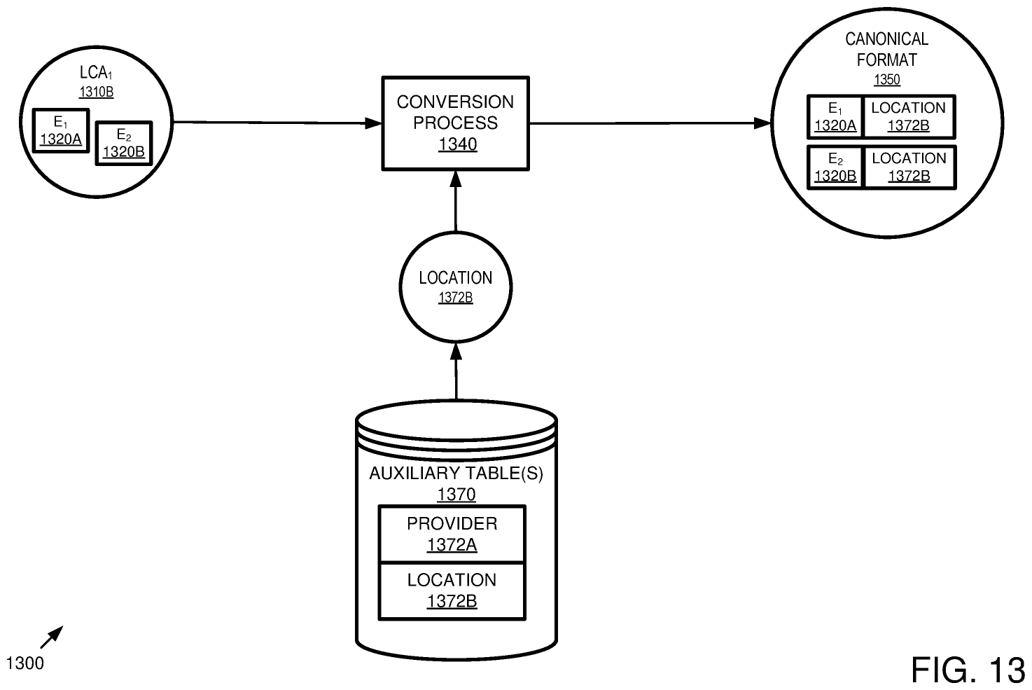

FIG. 13 is a block diagram of an example system 1300 implementing geographical location indication annotation scenario. In the example, sustainability reference content 1310B is being converted into canonical format 1350 by a conversion process 1340.

In some cases, geographical location indications are absent from the content 1310B. To determine a location, an auxiliary table 1370 can persist relationships between providers 1372A and locations 1372B. During import of the content 1310B, the conversion process 1340 can draw upon the auxiliary table 1370 for geographical location indication 1372B, which is then used to annotate the emission factors (e.g., 1320A, 1320B) with the location 1372B. As shown, more than one emission factor can be annotated with the same location indication.

Thus, responsive to determining that the content 1310B does not contain geographical location indications, the conversion process can query an auxiliary table 1370 with the provider identifier 1372A to determine a geographical location indication 1372B. The conversion process 1340 can then annotate a plurality of emission factors 1320A, 1320B with the geographical location indication 1372B in the canonical format 1350.

If the information is not available in the table 1370, a user interface element can be presented by which a user identifier can manually select a location (e.g., a location code such as “DE”). Such a selected geographical location identifier can then be used for annotation.

Such an approach can be helpful for global scenarios, where sustainability reference content may be relevant to a wide variety of geographical locations. By annotating the canonical format with the geographical location indications, global scenarios can be supported.

### Example 21—Example Validity Time Window

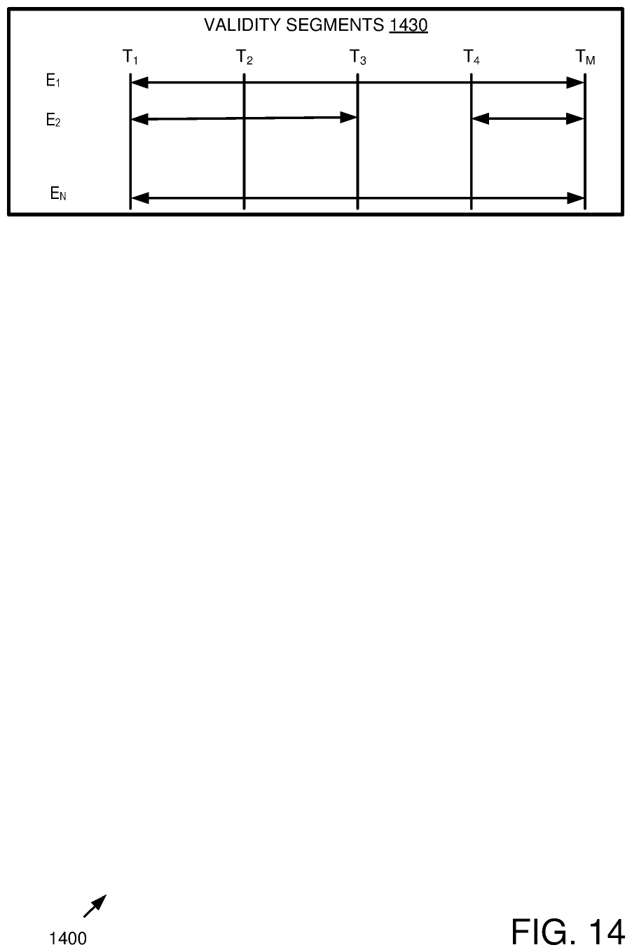

FIG. 14 is a block diagram of an example validity time window implementation 1400 for emission factors and can be used in any of the examples herein. In the example, time segments are specified for various of the emission factors. When calculating footprint, the validity time window can be taken into account. For example, if the data is expired or if the calculation is being done for a time period outside of the window, the reference emission factor can be excluded from the calculation. An alert regarding expiration can be raised, or other data (e.g., perhaps of lower quality) can be used instead.

### Example 22—Summary of an Example Embodiment

The emission factors can be imported. In the example, emission factors are the industry standard data which gives the details of the environmental impact based on different parameters like carbon impact or water impact for a specific material depending on certain factors like for example country of origin. An example is the footprint factor, such as 1.1 kg CO₂e for 1 kg sugar.

There are multiple options provided to import emission factors. There can be API communication with Life cycle assessment (LCA) content providers. For example, say for eEcoinvent, there can be an adapter, specific to eEcoinvent data, which can help in converting the eEcoinvent data to the canonical format. eEcoinvent is just used as one example, there can be multiple such LCA content providers and each of them can communicate with the product footprint management system, and using LCA specific adapters, one can convert the data to canonical format.

Another option is to get the LCA data imported though a manual import of file. Customers can fill up the emission factor data in spreadsheet template. Downloading the template and importing the data file manually can be done using the application—Manage Emission factors.

After the emission factors are imported and stored, the emission factors in canonical format can be used by many applications, for example the SAP Product Footprint Management system to calculate product persisted. And it can also support downloading the emission factors in canonical format easily using the application manage emission factors; publishing the emission factors in canonical format onto the shared repository.

After the emission factors which are either calculated or acquired, they can then be used in the trusted business networks.

Reliable calculations for footprint calculations can use reliable sustainability reference content, which is basically external data, provided by lifecycle assessment content providers gathering it from other sources or by partners like suppliers. The choice of the content provider depends on the customer and can be decided on a variety of parameters like diversity of data, reliability of data, accuracy of data etc. The decision also depends on the sector, industry, or the nature of business that the customer operates in. Supplier's footprint factors are included by standard formats and APIs.

Therefore, importing the content into the calculation service (e.g., product footprint management) in a standardized way can be supported.

### Example 23—Summary of Another Example Embodiment

The technologies can provide a data model that is simple for users in the form of a canonical format for emission factors.

There is flexibility to get the Emission Factors from any LCA provider and use it for footprint calculation. The format is not tightly coupled with any LCA provider specifically, rather a general model which can recognize and convert the emission factors from any LCA format to the canonical format.

Multiple industry formats can be supported with out of box converters. Automatic conversion of LCA providers' specific format to the canonical format.

Instead of hardcoding the model in a way that it only understands specific LCA provided emission factors, the format is generalized so that there is no manual conversion of the emission factors while importing.

‘Bring Your Own Content’ can be supported for the emission factors apart from the LCA providers. Customers can also bring any data from their own sources in canonical format and the same can be used in the footprint calculation.

An API can be provided to partners (e.g., LCA providers, Customers) to push the emission factors regularly (e.g., monthly, quarterly, yearly) to the product footprint management system. LCA partners and customers can use the APIs to update the content regularly. This will also help partners and customers to update the emission factors automatically without any manual intervention. The interval can be configured, and APIs can be called based on the configuration. This will also help partners and customers to update the emission factors automatically without any manual intervention.

A network of emission factors can be created for shared usage across different entities in the ecosystem. A mechanism to share/publish the emission factor among partners can be supported so that it can be used as an emission factor repository to calculate the footprint. Emission factors can also be shared/published in a common repository if the configuration is set by the LCA providers and customers. They can choose to share the emission factors, also they can use the shared emission factors by any other customers if it is available in the repository.

Upgrades and version management for the emission factors can be supported. A detailed version management is available to handle the regular, multiple updates of emission factors.

A user interface to manage the emission factors can be supported. A UI application can help customers manage the emission factors. The application will help them view and create the emission factors. They can also download the shared emission factors from other customers.

Try and buy enablement for the emission factors can be supported. Customers can use the emission factors on a trial basis and choose to buy them.

LCA adapters can be intelligent to detect the format of the input emission factors. Machine learning (classification) algorithms can be used to detect the input format automatically. This can help especially when a user imports the data without explicitly mentioning the format.

### Example 24—Example Implementations

Clause 1. A computer-implemented method comprising:
receiving a persisted representation of reference content comprising one or more reference emission factors;
converting the persisted representation of the reference content to a canonical format, wherein the reference content in the canonical format comprises the one or more reference emission factors; and
communicating the reference content in the canonical format to a footprint analysis engine.
Clause 2. The method of Clause 1, wherein:
the converting comprises organizing the persisted representation of reference content according to a pre-defined template; and
converting the organized, persisted representation of the reference content to the canonical format.
Clause 3. The method of Clause 2, wherein:
the pre-defined template comprises sections for emission dataset, emission factors, dataset classifications, dataset attributes, and dataset qualities.
Clause 4. The method of Clause 3, wherein:
the dataset attributes section supports arbitrary attributes.
Clause 5. The method of any one of Clauses 1-4, wherein:
converting the persisted representation of the reference content to the canonical format comprises persisting metadata specifying a source of the reference content.
Clause 6. The method of Clause 5, wherein:
the source of the reference content is a LCA provider; and
converting the persisted representation of the reference content to the canonical format comprises persisting metadata specifying a unique identifier specified by the LCA provider for an item component.
Clause 7. The method of any one of Clauses 1-6, further comprising:
by the footprint analysis engine, with the reference content in the canonical format, calculating a footprint for an item, wherein the calculating incorporates at least one of the one or more reference emission factors.
Clause 8. The method of Clause 7, wherein:
the reference content comprises a plurality of reference emission factors for respective geographical locations; and
the method further comprises:
converting the plurality of reference emission factors for respective geographical locations into the canonical format; and
by the footprint analysis engine, with the reference content in the canonical format, calculating a footprint for an item, wherein the calculating chooses one of the plurality of reference emission factors for respective geographical locations in the canonical format and applies the chosen reference emission factor during footprint calculation.
Clause 9. The method of Clause 8, wherein:
the choosing is based on a geographical location indicated in a database for an item.
Clause 10. The method of any one of Clauses 7-9, wherein:
the reference content comprises a reference emission factor expressed in a first unit of measure; and
the method further comprises:
converting emission factor expressed in a first unit of measure into the canonical format, wherein the converting comprises converting the reference emission factor into a second unit of measure specified by the canonical format; and
by the footprint analysis engine, with the reference content in the canonical format, calculating a footprint for an item, wherein the calculating multiplies the converted reference emission factor by a quantity during footprint calculation.
Clause 11. The method of Clause 10, wherein:
the first unit of measure specifies a weight; and
the converting converts the reference emission factor to kilograms.
Clause 12. The method of any one of Clauses 10-11, wherein:
the first unit of measure specifies a distance; and
the converting converts the reference emission factor to kilometers.
Clause 13. The method of any one of Clauses 7-12, wherein:
the reference content comprises a plurality of reference emission factors for respective transport modes; and
the method further comprises:
converting the plurality of reference emission factors for respective transport modes into the canonical format; and
by the footprint analysis engine, with the reference content in the canonical format, calculating a footprint for an item, wherein the calculating chooses one of the plurality of reference emission factors for respective transport modes in the canonical format and applies the chosen reference emission factor during footprint calculation.
Clause 14. The method of any one of Clauses 1-13, further comprising:
importing data via a reference content connector.
Clause 15. The method of any one of Clauses 1-14, wherein:
the reference content in the canonical format is persisted in a reference content library; and
the method further comprises:
providing an API configured to receive an indication that additional reference content is available;
via the API, receiving an indication that additional reference content is available; and
responsive to the indication received via the API, persisting the additional reference content in the reference content library.
Clause 16. The method of any one of Clauses 1-15, wherein:
receiving the persisted representation of reference content comprising one or more reference emission factors comprises receiving manually entered data from a user identifier.
Clause 17. The method of any one of Clauses 1-16, further comprising:
applying the reference content in the canonical format to cleaning operations; and
applying the reference content in the canonical format to EHS conformity.
Clause 18. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
receiving a persisted representation of reference content comprising one or more reference emission factors;
organizing the persisted representation of reference content according to a pre-defined template;
converting the organized, persisted representation of reference content to a canonical format, wherein the reference content in the canonical format comprises the one or more reference emission factors; and
communicating the reference content in the canonical format to a footprint analysis engine.
Clause 19. The computing system of Clause 18, further comprising:
a LCA content provider-specific adapter configured to receive reference content from a particular LCA content provider and communicate with a data ingest/export comprising an inbound data handler, wherein the data ingest/export is configured to persist the reference content in the canonical format; and
an application configured to present a user interface configured to manipulate emission factors.
Clause 20. One or more non-transitory computer-readable media comprising computer-executable instructions that, when executed by a computing system, cause the computing system to perform operations comprising:
receiving a persisted representation of reference content comprising one or more reference emission factors;
organizing the persisted representation of reference content according to a pre-defined template;
converting the organized, persisted representation of the reference content to a canonical format, wherein the reference content in the canonical format comprises the one or more reference emission factors;
communicating the reference content in the canonical format to a footprint analysis engine; and
by the footprint analysis engine, with the reference content in the canonical format, calculating a footprint for an item, wherein the calculating incorporates at least one of the one or more reference emission factors.
Clause 21. One or more non-transitory computer-readable media comprising computer-executable instructions that, when executed by a computing system, cause the computing system to perform them method of any one of Clauses 1-17.

### Example 25—Example Advantages

A number of advantages can be achieved via the technologies described herein. For example, because the data is persisted in a canonical format, analysis can be performed across applications in a uniform way, making calculations efficient and reliable. For example, units of measure can be uniform, avoiding possible errors related to a mismatch of units.

As described herein, the canonical format can include information about geographical indications and validity windows. Thus, automated selection of reference emission factors can be achieved instead of manual entry. In practice, manual calculation of product footprint can omit such factors because they may not even be available in a manual scenario.

Further, avoiding manual entry avoids errors due to typographical errors or misunderstanding of data models.

Also, there is a huge scope of reuse of data across multiple solutions as described herein.

### Example 26—Example Computing Systems

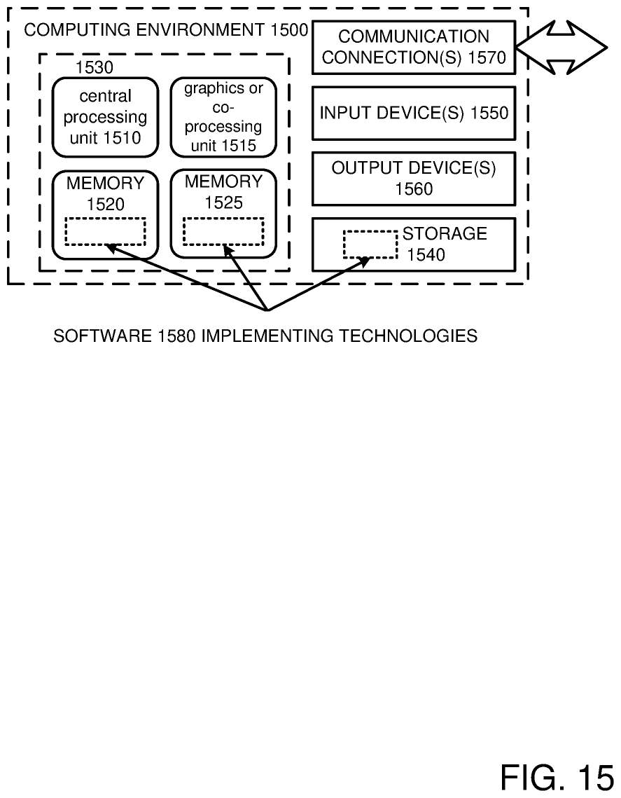

FIG. 15 depicts an example of a suitable computing system 1500 in which the described innovations can be implemented. The computing system 1500 is not intended to suggest any limitation as to scope of use or functionality of the present disclosure, as the innovations can be implemented in diverse computing systems.

With reference to FIG. 15, the computing system 1500 includes one or more processing units 1510, 1515 and memory 1520, 1525. In FIG. 15, this basic configuration 1530 is included within a dashed line. The processing units 1510, 1515 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 15 shows a central processing unit 1510 as well as a graphics processing unit or co-processing unit 1515. The tangible memory 1520, 1525 can be volatile memory (e.g., registers, cache, RAM), non-volatile memory (e.g., ROM, EEPROM, flash memory, etc.), or some combination of the two, accessible by the processing unit(s) 1510, 1515. The memory 1520, 1525 stores software 1580 implementing one or more innovations described herein, in the form of computer-executable instructions suitable for execution by the processing unit(s) 1510, 1515.

A computing system 1500 can have additional features. For example, the computing system 1500 includes storage 1540, one or more input devices 1550, one or more output devices 1560, and one or more communication connections 1570, including input devices, output devices, and communication connections for interacting with a user. An interconnection mechanism (not shown) such as a bus, controller, or network interconnects the components of the computing system 1500. Typically, operating system software (not shown) provides an operating environment for other software executing in the computing system 1500, and coordinates activities of the components of the computing system 1500.

The tangible storage 1540 can be removable or non-removable, and includes magnetic disks, magnetic tapes or cassettes, CD-ROMs, DVDs, or any other medium which can be used to store information in a non-transitory way and which can be accessed within the computing system 1500. The storage 1540 stores instructions for the software 1580 implementing one or more innovations described herein.

The input device(s) 1550 can be an input device such as a keyboard, mouse, pen, or trackball, a voice input device, a scanning device, touch device (e.g., touchpad, display, or the like) or another device that provides input to the computing system 1500. The output device(s) 1560 can be a display, printer, speaker, CD-writer, or another device that provides output from the computing system 1500.

The communication connection(s) 1570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 27—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 28—Example Cloud Computing Environment

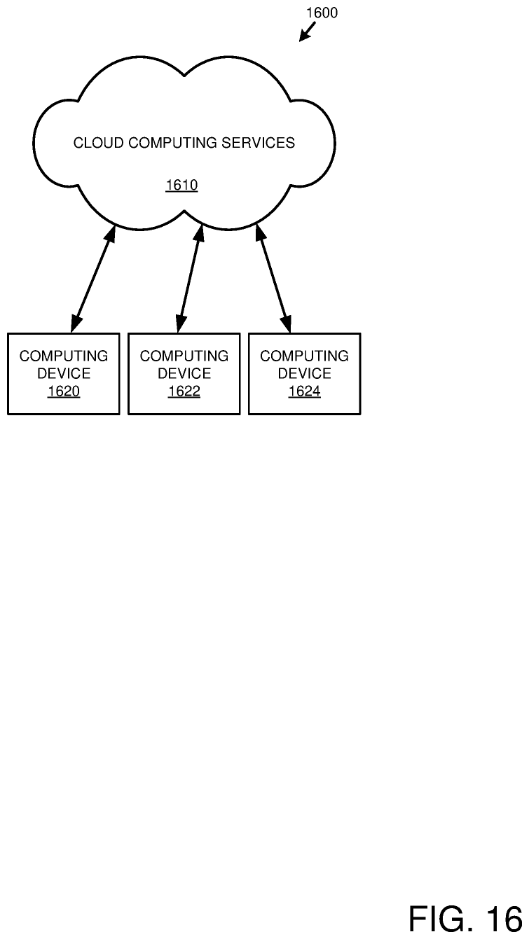

FIG. 16 depicts an example cloud computing environment 1600 in which the described technologies can be implemented, including, e.g., the system 100 of FIG. 1 and other systems herein. The cloud computing environment 1600 comprises cloud computing services 1610. The cloud computing services 1610 can comprise various types of cloud computing resources, such as computer servers, data storage repositories, networking resources, etc. The cloud computing services 1610 can be centrally located (e.g., provided by a data center of a business or organization) or distributed (e.g., provided by various computing resources located at different locations, such as different data centers and/or located in different cities or countries).

The cloud computing services 1610 are utilized by various types of computing devices (e.g., client computing devices), such as computing devices 1620, 1622, and 1624. For example, the computing devices (e.g., 1620, 1622, and 1624) can be computers (e.g., desktop or laptop computers), mobile devices (e.g., tablet computers or smart phones), or other types of computing devices. For example, the computing devices (e.g., 1620, 1622, and 1624) can utilize the cloud computing services 1610 to perform computing operations (e.g., data processing, data storage, and the like).

In practice, cloud-based, on-premises-based, or hybrid scenarios can be supported.

### Example 29—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 30—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a persisted representation of reference content comprising one or more reference emission factors;
converting the persisted representation of the reference content to a canonical format, wherein the reference content in the canonical format comprises the one or more reference emission factors; and
communicating the reference content in the canonical format to a footprint analysis engine.

2. The method of claim 1, wherein:
the converting comprises organizing the persisted representation of reference content according to a pre-defined template; and
converting the organized, persisted representation of the reference content to the canonical format.

3. The method of claim 2, wherein:
the pre-defined template comprises sections for emission dataset, emission factors, dataset classifications, dataset attributes, and dataset qualities.

4. The method of claim 3, wherein:
the dataset attributes section supports arbitrary attributes.

5. The method of claim 1, wherein:
converting the persisted representation of the reference content to the canonical format comprises persisting metadata specifying a source of the reference content.

6. The method of claim 5, wherein:
the source of the reference content is a LCA provider; and
converting the persisted representation of the reference content to the canonical format comprises persisting metadata specifying a unique identifier specified by the LCA provider for an item component.

7. The method of claim 1, further comprising:
by the footprint analysis engine, with the reference content in the canonical format, calculating a footprint for an item, wherein the calculating incorporates at least one of the one or more reference emission factors.

8. The method of claim 7, wherein:
the reference content comprises a plurality of reference emission factors for respective geographical locations; and
the method further comprises:
converting the plurality of reference emission factors for respective geographical locations into the canonical format; and
by the footprint analysis engine, with the reference content in the canonical format, calculating a footprint for an item, wherein the calculating chooses one of the plurality of reference emission factors for respective geographical locations in the canonical format and applies the chosen reference emission factor during footprint calculation.

9. The method of claim 8, wherein:
the choosing is based on a geographical location indicated in a database for an item.

10. The method of claim 7, wherein:
the reference content comprises a reference emission factor expressed in a first unit of measure; and
the method further comprises:
converting emission factor expressed in a first unit of measure into the canonical format, wherein the converting comprises converting the reference emission factor into a second unit of measure specified by the canonical format; and
by the footprint analysis engine, with the reference content in the canonical format, calculating a footprint for an item, wherein the calculating multiplies the converted reference emission factor by a quantity during footprint calculation.

11. The method of claim 10, wherein:
the first unit of measure specifies a weight; and
the converting converts the reference emission factor to kilograms.

12. The method of claim 10, wherein:
the first unit of measure specifies a distance; and
the converting converts the reference emission factor to kilometers.

13. The method of claim 7, wherein:
the reference content comprises a plurality of reference emission factors for respective transport modes; and
the method further comprises:
converting the plurality of reference emission factors for respective transport modes into the canonical format; and
by the footprint analysis engine, with the reference content in the canonical format, calculating a footprint for an item, wherein the calculating chooses one of the plurality of reference emission factors for respective transport modes in the canonical format and applies the chosen reference emission factor during footprint calculation.

14. The method of claim 1, further comprising:
importing data via a reference content connector.

15. The method of claim 1, wherein:
the reference content in the canonical format is persisted in a reference content library; and
the method further comprises:
providing an API configured to receive an indication that additional reference content is available;
via the API, receiving an indication that additional reference content is available; and
responsive to the indication received via the API, persisting the additional reference content in the reference content library.

16. The method of claim 1, wherein:
receiving the persisted representation of reference content comprising one or more reference emission factors comprises receiving manually entered data from a user identifier.

17. The method of claim 1, further comprising:
applying the reference content in the canonical format to cleaning operations; and
applying the reference content in the canonical format to EHS conformity.

18. A computing system comprising:
at least one hardware processor;
at least one memory coupled to the at least one hardware processor; and
one or more non-transitory computer-readable media having stored therein computer-executable instructions that, when executed by the computing system, cause the computing system to perform:
receiving a persisted representation of reference content comprising one or more reference emission factors;
organizing the persisted representation of reference content according to a pre-defined template;
converting the organized, persisted representation of reference content to a canonical format, wherein the reference content in the canonical format comprises the one or more reference emission factors; and
communicating the reference content in the canonical format to a footprint analysis engine.

19. The computing system of claim 18 further comprising:
a LCA content provider-specific adapter configured to receive reference content from a particular LCA content provider and communicate with a data ingest/export comprising an inbound data handler, wherein the data ingest/export is configured to persist the reference content in the canonical format; and
an application configured to present a user interface configured to manipulate emission factors.

20. One or more non-transitory computer-readable media comprising computer-executable instructions that, when executed by a computing system, cause the computing system to perform operations comprising:
receiving a persisted representation of reference content comprising one or more reference emission factors;
organizing the persisted representation of reference content according to a pre-defined template;
converting the organized, persisted representation of the reference content to a canonical format, wherein the reference content in the canonical format comprises the one or more reference emission factors;
communicating the reference content in the canonical format to a footprint analysis engine; and
by the footprint analysis engine, with the reference content in the canonical format, calculating a footprint for an item, wherein the calculating incorporates at least one of the one or more reference emission factors.
